(19) United States
(12) Patent Application Publication
(10) Pub. No.: US 2021/0347660 A1
(43) Pub. Date: Nov. 11, 2021

(54) METHOD FOR RESTORING ECOLOGICAL ENVIRONMENT BY UTILIZING EMERGENT AQUATIC PLANTS

(71) Applicant: CHINESE RESEARCH ACADEMY OF ENVIRONMENTAL SCIENCES, Beijing (CN)

(72) Inventors: Lieyu Zhang, Beijing (CN); Caole Li, Beijing (CN); Chen Zhao, Beijing (CN); Xiaoguang Li, Beijing (CN); Guowen Li, Beijing (CN); Wei Li, Beijing (CN); Jiaqian Li, Beijing (CN); Qiuheng Zhu, Beijing (CN); Lulu Che, Beijing (CN)

(21) Appl. No.: 17/281,065

(22) PCT Filed: Sep. 15, 2020
(86) PCT No.: PCT/CN2020/115349

§ 371 Date: Mar. 29, 2021

(30) Foreign Application Priority Data
Sep. 29, 2019 (CN) 2019109315758

(51) Int. Cl. C02F 3/32; A01G 22/00; C02F 1/48

(52) U.S. Cl. CPC C02F 3/32; C02F 2209/08; C02F 1/48; A01G 22/00

(57) ABSTRACT

The present invention relates to the field of water environment treatment, and particularly discloses a method for restoring an ecological environment by utilizing emergent aquatic plants. According to the present invention, by arranging a magnetization reactor around the emergent aquatic plants to carry out intermittent magnetization induction on the emergent aquatic plants, the available quantity of plant root systems for mineralized substances in a micro-environment, such as inorganic phosphorus and the like, is increased, the limitation of maximum biomass is broken through, the oxygen conveying effect of the roots of the aquatic plants is promoted, and the hydraulic transmission effect is maintained and enhanced; and under the condition that the planting density of the plants is not increased, the pollutant absorption and conversion capacity of the emergent aquatic plants is promoted and improved, and the purification and ecological restoration efficiency of the emergent aquatic plants for a water environment is improved by about 30%.

### TECHNICAL FIELD

The present invention relates to the field of water environment treatment, and more particularly, to a method for restoring an ecological environment by utilizing emergent aquatic plants.

### BACKGROUND

In an aquatic ecosystem, aquatic plants are the key ecological groups for maintaining the virtuous development of a water body. The aquatic plants are in the primary producer position in the aquatic ecosystem, convert solar energy into organic matter by photosynthesis to produce a great quantity of organic substances to provide direct or indirect foods for aquatic animals and humans, and meanwhile, the aquatic plants are also the key of maintaining a virtuous cycle of the aquatic ecosystem and are also the basis of aquatic biotic community diversities. Thus, a complete aquatic plant community is a key factor of maintaining a structure and functions of the aquatic ecosystem.

Roots and rhizomes of emergent aquatic plants grow in bottom sludge of water, stems and leaves emerge from the water surface, and the emergent aquatic plants are commonly distributed at the position of shallow water at a depth of 0 to 1.5 meters, wherein some species grow on the wet bank. For such species of plants, parts in the air have the characteristics of terrestrial plants, and parts (the roots or subterraneous stems) grow in the water have the characteristics of the aquatic plants.

The emergent aquatic plants can reduce wind-wave disturbance by resistance to water stream to enable suspended substances to be settled. Waterway ecotone dominated by the emergent aquatic plants on the river and lake banks is beneficial to removal and sedimentation of non-point source pollutants and the like. However, root systems of some emergent aquatic plants are relatively low in vigor, resulting in poor pollutant absorption and conversion capacity of the emergent aquatic plants. Generally, an enrichment quantity and purification efficiency of the aquatic plants for the pollutants in a water body environment is closely related to plant biomass, and thus, the purification efficiency of the aquatic plants can be improved only by increasing a density of the plants.

### SUMMARY

The present invention aims to provide a novel method for restoring an ecological environment by utilizing emergent aquatic plants. Under the condition that a planting density of the plants is not increased, the purification and ecological restoration efficiency of the emergent aquatic plants for a water environment may be improved by promoting and improving pollutant absorption and conversion capacity of the emergent aquatic plants.

To fulfill the aim, the technical solution of the present invention is as follows:

The present invention provides a method for restoring an ecological environment by utilizing emergent aquatic plants. The core of the method lies in that a magnetization reactor is arranged around the emergent aquatic plants to carry out intermittent magnetization induction on the emergent aquatic plants and a water environment where the emergent aquatic plants are located to promote ecological restoration of the water environment.

Existence forms of the emergent aquatic plants can include direct planting, an ecological floating island, a constructed wetland, and the like. The emergent aquatic plants are selected from one or more of typha angustifolia linn (typha angustifolia), lotuses, bowl lotuses, phragmites australis, typha orientalis, zizania latifolia (zizania cadudciflora, zizania aquatica), scirpus validus vahl, giant reed, phyllostachys heteroclada, scirpus validus vahl, acorns calamus linn, cortaderia selloana and sparganium stoloniferum.

Preferably, the present invention provides several combination modes of the emergent aquatic plants:

(1) The lotuses, the typha orientalis and the scirpus validus vahl, according to a plant density ratio of 5:1:1;

(2) The acorns calamus linn, the cortaderia selloana and the sparganium stoloniferum, according to a plant density ratio of 1:1:1; and

(3) The typha angustifolia, the bowl lotuses and the phragmites australis, according to a plant density ratio of 1:2:1.

The plant density ratio refers to a ratio of plant numbers in unit area.

Optionally, the magnetization reactor adopts a permanent magnetic type or an electromagnetic type and can carry out flexible selection according to field water quality, a water volume and power supply in the practical application.

As exemplary illustration, for example, the field water quality is inferior to class-V water quality, the water volume is greater than or equal to 2,000 m³/d, the field power supply is stable, and preferably, the electromagnetic type magnetization reactor is adopted, such as a pipeline-type adjustable electromagnetic type magnetization reactor.

For further example, the field water quality is within class-V water quality, the water volume is smaller than 1,000 m³/d, the field power supply capacity is poor, preferably, the permanent magnetic type magnetization reactor is adopted, and a permanent magnet material of the permanent magnetic type magnetization reactor is selected from ferrite, neodymium iron boron or iron cobalt vanadium.

Further, magnetic field intensity for carrying out intermittent magnetization induction on the emergent aquatic plants and a water environment where the emergent aquatic plants are located is 50 mT to 500 mT, an intermittent period is 3 h to 48 h, and one-time magnetization time is 5 min to 120 min.

Further, for different emergent aquatic plants and the combinations thereof, the present invention explores different magnetization conditions to benefit for playing the optimal purification/restoration effect by the emergent aquatic plants and the combinations thereof. The above-mentioned preferred emergent aquatic plant combinations correspond to the following better magnetization parameters:

(1) For the combination of the lotuses, the typha orientalis and the scirpus validus vahl, the plant density ratio is 5:1:1; and the magnetic field intensity for intermittent magnetization is 400 mT, the intermittent period is 5 h, and the one-time magnetization time is 20 min;

(2) For the combination of the acorns calamus linn, the cortaderia selloana and the sparganium stoloniferum, the plant density ratio is 1:1:1; and the magnetic field intensity for intermittent magnetization is 200 mT, the intermittent period is 15 h, and the one-time magnetization time is 60 min; and

(3) For the combination of the typha angustifolia, the bowl lotuses and the phragmites australis, the plant density ratio is 1:2:1: and the magnetic field intensity for intermittent magnetization is 100 mT, the intermittent period is 30 h, and the one-time magnetization time is 90 min.

Purification and ecological restoration of the emergent aquatic plants on the water environment are mainly reflected in purification and restoration on sewage entering a growth environment (or called as a restoration system) of the emergent aquatic plants.

In the initial period that the sewage enters the restoration system constituted by the emergent aquatic plants, the adsorption effect of a substrate and root systems, the decomposition effect of microorganisms and the absorption effect of the plants coexist, and magnetization induction enables both the plants and the microorganisms to be in a rapid growth or reproduction stage, so that a pollutant removal rate is relatively large. In the later period, the adsorption effect of the substrate and the root systems has gradually approached saturation and growth of the root systems also tends to maturity, and thus, by continuously applying the magnetization reaction, pollutants adsorbed by the plants are rapidly transformed, the available quantity of the plant root systems for mineralized substances in a micro-environment, such as inorganic phosphorus, and the like, is increased, the limitation of maximum biomass is broken through, the reproduction rate of the emergent aquatic plants cannot be reduced, and the pollutant removal rate can still be maintained at a certain level.

The emergent aquatic plants are rooted in bottom sludge and use the bottom sludge as a growth substrate, so that not only can circulation of a water body and nutrient substances in the bottom sludge be implemented and content of the nutrient substances and heavy metals in sediments be reduced, but also a dynamic state of the water body can be changed, and effects of water flow scour and the like can be reduced. The wetland bottom sludge by which the emergent aquatic plants live contains rich nutrient substances, plant and animal residues, and the like, the bottom sludge can provide a certain energy and habitat for aquatic animals and plants, but also can become a source or a sink of the water body pollutants. A study finds that the wetland bottom sludge and the nutrient substances in the water body, such as nitrogen, phosphorus, organic matter, and the like, can be absorbed and released mutually under certain conditions, resulting in secondary pollution to the water body. The emergent aquatic plants, as a bridge between the bottom sludge and the water body may play a key role in matter conversion between the bottom sludge and the water body.

The root systems of the aquatic plants can deeply penetrate a medium layer of the constructed wetland, and the magnetization induction effect can enable the plant root systems to form numerous gaps and air chambers in the medium layer to effectively avoid blockage inside a medium, increase a medium porosity and ensure and enhance hydraulic transmission capacity in the medium. Growth of the plants can improve a hydraulic transmission speed of natural soil, and when the plants are matured, water capacity of a root zone system is increased, and even though the root systems of the plants are rotted, many gaps and passages are still reserved, thereby benefiting the hydraulic transmission of the soil and maintaining and enhancing the hydraulic transmission effect.

The wetland soil is severely lack of oxygen, and the low oxygen content of the soil is very disadvantageous for the survival of many living things. Under the oxygen-deficient condition, the living things cannot carry out normal aerobic respiration, and the concentration of certain elements and organic matter in a reduced state can reach a toxic level. The aquatic plants can generate oxygen by photosynthesis. The magnetization induction effect can promote the formation of the micro-environment in an oxidized state around the plant roots, not only an aerobic environment suitable for aerobic microorganisms to live can be formed, but also an anaerobic environment suitable for anaerobic microorganisms to live can be formed, different microorganisms can coexist, respectively take what they need and sufficiently absorb and utilize nutrients in the water, and eutrophic substances in the water are reduced, thereby achieving a water purification effect.

The present invention at least has the beneficial effects that:

According to the present invention, by arranging the magnetization reactor around the emergent aquatic plants to carry out intermittent magnetization induction on the emergent aquatic plants, the available quantity of the plant root systems for the mineralized substances in the micro-environment, such as inorganic phosphorus, and the like, is increased, the limitation of the maximum biomass is broken through, the oxygen conveying effect of the roots of the aquatic plants is promoted, and the hydraulic transmission effect is maintained and enhanced; and under the condition that the planting density of the plants is not increased, the pollutant absorption and conversion capacity of the emergent aquatic plants is promoted and improved, and the purification and ecological restoration efficiency of the emergent aquatic plants for the water environment is improved by about 30%.

### DETAILED DESCRIPTION

Preferred embodiments of the present invention will be illustrated in detail below in connection with embodiments. It should be understood that embodiments given below are merely used for illustration, rather than limiting the scope of the present invention. Those of ordinary skill in the art, without departing from the purpose and the spirit of the present invention, can make various modifications and replacements to the present invention.

Experimental methods used in the below-mentioned embodiments, unless otherwise specifically illustrated, are all conventional methods.

Materials, reagents, and the like used in the below-mentioned embodiments, unless otherwise specifically illustrated, all can be obtained by commercial approaches.

### Embodiment 1

By taking an ecological floating island with an area of 25 m² in a 10 m*10 m closed water body region as an example, water quality is class-IV water, Chemical Oxygen Demand (COD) is 60 mg/L, a water volume is 500 m³/d, field power supply capacity is poor, the ecological floating island is planted with emergent aquatic plants including lotuses, typha orientalis and scirpus validus vahl, a plant density ratio is 5:1:1, a permanent magnetic type magnetization reactor made of a ferrite material is adopted, magnetic field intensity is 400 mT, intermittent magnetization induction is carried out, an intermittent period is 5 h, and one-time magnetization time is 20 min. Water quality measurement is carried out after 10 days, 30 days, 50 days and 70 days, and a measurement method includes:

Taking water samples on the tenth day, the thirtieth day, the fiftieth day and the seventieth day, and carrying out measurement on COD of the water samples according to a dichromate measurement method (GB11914-89) of the COD.

A result shows that the COD is respectively reduced to 28 mg/L, 25 mg/L, 21 mg/L and 17 mg/L, and reaches the class-III water standard after 70 days.

### CONTRAST EXAMPLE 1A

This contrast example differs from Embodiment 1 in that: magnetization induction is not carried out on the ecological floating island, and the water quality is restored only by the ecological floating island and the planted emergent aquatic plants.

Measurement of the water quality and the plants is respectively carried out after 10 days, 30 days, 50 days and 70 days, and a result shows that the COD is respectively reduced to 45 mg/L, 37 mg/L, 35 mg/L and 32 mg/L, and reaches the class-IV water standard after 70 days.

### CONTRAST EXAMPLE 1B

This contrast example differs from Embodiment 1 in that: the emergent aquatic plants are not planted on the ecological floating island.

The water quality is restored by the ecological floating island and the intermittent magnetization effect.

Measurement of the water quality and the plants is respectively carried out after 10 days, 30 days, 50 days and 70 days, and a result shows that the COD is respectively reduced to 58 mg/L, 56 mg/L, 51 mg/L and 48 mg/L, and reaches the class-V water standard after 70 days.

### Embodiment 2

By taking an ecological floating island with an area of 25 m² in a 10 m*10 m closed water body region as an example, water quality is class-IV water, COD is 60 mg/L, a water volume is 500 m³/d, field power supply capacity is poor, the ecological floating island is planted with emergent aquatic plants including acorns calamus linn, cortaderia selloana and sparganium stoloniferum, a plant density ratio is 1:1:1, a permanent magnetic type magnetization reactor made of a ferrite material is adopted, magnetic field intensity is 200 mT, intermittent magnetization induction is carried out, an intermittent period is 15 h, and one-time magnetization time is 60 min. Water quality measurement is carried out after 10 days, 30 days, 50 days and 70 days, and a result shows that the COD is respectively reduced to 25 mg/L, 25 mg/L, 20 mg/L and 19 mg/L, and reaches the class-III water standard after 70 days.

### CONTRAST EXAMPLE 2A

This contrast example differs from Embodiment 2 in that: magnetization induction is not carried out on the ecological floating island, and the water quality is restored only by the ecological floating island and the planted emergent aquatic plants.

Measurement of the water quality and the plants is respectively carried out after 10 days, 30 days, 50 days and 70 days, and a result shows that the COD is respectively reduced to 46 mg/L, 38 mg/L, 35 mg/L and 32 mg/L, and reaches the class-IV water standard after 70 days.

### CONTRAST EXAMPLE 2B

This contrast example differs from Embodiment 2 in that: the emergent aquatic plants are not planted on the ecological floating island.

The water quality is restored by the ecological floating island and the intermittent magnetization effect.

Measurement of the water quality and the plants is respectively carried out after 10 days, 30 days, 50 days and 70 days, and a result shows that the COD is respectively reduced to 58 mg/L, 56 mg/L, 51 mg/L and 48 mg/L, and reaches the class-V water standard after 70 days.

### Embodiment 3

By taking an ecological floating island with an area of 25 m² in a 10 m*10 m closed water body region as an example, water quality is class-IV water, COD is 60 mg/L, a water volume is 500 m³/d, field power supply capacity is poor, the ecological floating island is planted with emergent aquatic plants including typha angustifolia, bowl lotuses and phragmites australis, a plant density ratio is 1:2:1, a permanent magnetic type magnetization reactor made of a ferrite material is adopted, magnetic field intensity is 100 mT, intermittent magnetization induction is carried out, an intermittent period is 30 h, and one-time magnetization time is 90 min. Water quality measurement is carried out after 10 days, 30 days, 50 days and 70 days, and a result shows that the COD is respectively reduced to 28 mg/L, 25 mg/L, 21 mg/L and 17 mg/L, and reaches the class-III water standard after 70 days.

### CONTRAST EXAMPLE 3A

This contrast example differs from Embodiment 3 in that: magnetization induction is not carried out on the ecological floating island, and the water quality is restored only by the ecological floating island and the planted emergent aquatic plants.

Measurement of the water quality and the plants is respectively carried out after 10 days, 30 days, 50 days and 70 days, and a result shows that the COD is respectively reduced to 46 mg/L, 38 mg/L, 35 mg/L and 32 mg/L, and reaches the class-IV water standard after 70 days.

### CONTRAST EXAMPLE 3B

This contrast example differs from Embodiment 2 in that: the emergent aquatic plants are not planted on the ecological floating island.

The water quality is restored by the ecological floating island and the intermittent magnetization effect.

Measurement of the water quality and the plants is respectively carried out after 10 days, 30 days, 50 days and 70 days, and a result shows that the COD is respectively reduced to 58 mg/L, 56 mg/L, 51 mg/L and 48 mg/L, and reaches the class-V water standard after 70 days.

### CONTRAST EXAMPLE 4

By taking an ecological floating island with an area of 25 m² in a 10 m*10 m closed water body region as an example, the water quality is class-IV water. COD is 50 mg/L. A water volume is 500 m³/d. The field power supply capacity is poor. The ecological floating island is planted with emergent aquatic plants including wild rice shoots, phragmites australis, and cress. A plant density ratio is 2:2:1. A permanent magnetic type magnetization reactor made of a ferrite material is adopted. The magnetic field intensity is 400 Mt. Intermittent magnetization induction is carried out. An intermittent period is 5 h. One-time magnetization time is 20 min. Water quality measurement is carried out after 10 days, 30 days, 50 days and 70 days, and a measurement method includes:

Taking water samples on the tenth day, the thirtieth day, the fiftieth day and the seventieth day, and carrying out the measurement on COD of the water samples according to a dichromate measurement method (GB11914-89) of the COD.

Measurement of the water quality and the plants is respectively carried out after 10 days, 30 days, 50 days and 70 days, and a result shows that the COD is respectively reduced to 44 mg/L, 35 mg/L, 31 mg/L and 31 mg/L, and reaches the class-IV water standard after 70 days.

Although the present invention has been described above in great detail with general descriptions and specific embodiments, on the basis of the present invention, various modifications or improvements may be made, which is apparent to those of ordinary skill in the art. Therefore, all such modifications and improvements without departing from the spirit of the present invention are within the scope of the claims of the present invention.

1. A method for restoring an ecological environment by utilizing emergent aquatic plants, characterized in that a magnetization reactor is arranged around the emergent aquatic plants to carry out intermittent magnetization induction on the emergent aquatic plants and a water environment where the emergent aquatic plants are located to promote ecological restoration of the water environment.

2. The method according to claim 1, characterized in that intermittent magnetization is carried out on a water body, wherein the magnetic field intensity is 50 mT to 500 mT, an intermittent period is 3 h to 48 h, and one-time magnetization time is 5 min to 120 min.

3. The method according to claim 2, characterized in that the emergent aquatic plants are selected from one or more of typha angustifolia, lotuses, bowl lotuses, phragmites australis, typha orientalis, zizania latifolia, scirpus validus vahl, giant reed, phyllostachys heteroclada, scirpus validus vahl, acorns calamus linn, cortaderia selloana and sparganium stoloniferum.

4. The method according to claim 3, characterized in that the emergent aquatic plants are formed by a combination of the lotuses, the typha orientalis and the scirpus validus vahl, a plant density ratio of the lotuses to the typha orientalis to the scirpus validus vahl is 5:1:1, the magnetic field intensity of intermittent magnetization is 400 mT, the intermittent period is 5 h, and the one-time magnetization time is 20 min.

5. The method according to claim 3, characterized in that the emergent aquatic plants are formed by a combination of the acorns calamus linn, the cortaderia selloana and the sparganium stoloniferum, a plant density ratio of the acorns calamus linn to the cortaderia selloana to the sparganium stoloniferum is 1:1:1; and the magnetic field intensity of intermittent magnetization is 200 mT, the intermittent period is 15 h, and the one-time magnetization time is 60 min.

6. The method according to claim 3, characterized in that the emergent aquatic plants are formed by a combination of the typha angustifolia, the bowl lotuses and the phragmites australis, a plant density ratio of the typha angustifolia to the bowl lotuses to the phragmites australis is 1:2:1; and the magnetic field intensity of intermittent magnetization is 100 mT, the intermittent period is 30 h, and the one-time magnetization time is 90 min.
